(19) United States
(12) Patent Application Publication
(10) Pub. No.: US 2010/0248722 A1
(43) Pub. Date: Sep. 30, 2010

(54) METHOD FOR PREVENTING COVERAGE GAPS ON THE BORDERS OF A CELLULAR MOBILE COMMUNICATIONS SYSTEMS

(75) Inventors: Han Van Bussel, Bonn (DE); Axel Klatt, Koeln (DE)

Correspondence Address: KF ROSS PC, 5683 RIVERDALE AVENUE, SUITE 203 BOX 900, BRONX, NY, 10471-0900, US

(73) Assignee: DEUTSCHE TELEKOM AG, BONN (DE)

(21) Appl. No.: 12/681,137

(22) PCT Filed: Sep. 25, 2008
(86) PCT No.: PCT/EP2008/008175

§ 371 Date: May 4, 2010

(30) Foreign Application Priority Data
Nov. 23, 2007 (DE) 10 2007 056 787.3

(51) Int. Cl. H04W 36/16

(52) U.S. Cl. 455/436

(57) ABSTRACT

The invention relates to a method for operating a first cellular communications network, particularly for operating cells in the border region of the first cellular mobile communications network, wherein the first mobile communications network is identifiable by an identifier and, at least in border regions of the first mobile communications network, transmits the identifier of a second neighboring mobile communications network that is considered equivalent to a mobile communications terminal device to which a communications connection exists, wherein an at least partial spatial overlap of the communications ranges of the two mobile communications networks is present, wherein the mobile communications terminal device measures the communications signal strengths of the mobile communications networks currently receivable at the current location of the mobile communications terminal device, wherein the communications signal strengths measured by the communications terminal device and the associated identifiers of the respective mobile communications network are sent to the first mobile communications network for analysis, wherein the communications connection is transferred to the second neighboring mobile communications network if the communications signal strength of said network exceeds a predeterminable threshold value or is greater than the communications signal strength of the first mobile communications network.

The invention relates to a method of operating a first cellular communication network, in particular for operating cells in a border region of the first cellular mobile communication network, where the first mobile communication network is identifiable by an identifier and a mobile communication terminal to which a radio link exists transmits—at least in the border regions of the first mobile communication network—the identification of a second neighboring mobile communication network identified as being equivalent, an at least partial spatial overlap of the communication ranges of the two mobile communication networks being present, the mobile communication terminal measuring the communications signal strengths of the mobile communication networks that are can be received at that time at the current location of the mobile communication terminal.

In particular, the invention concerns a method of preventing gaps in coverage in border regions (specifically at country borders) of a cellular mobile communication network, for example, as per GSM, UMTS, cdma2000, E-UTRAN or WiMaX, WiBro, UMB standard, which according to current prior art, would occur, for example, on both sides of the border of a country in a public mobile communication system (PLMN) when the same frequencies are used, so that a reciprocal negative interference because of interference, especially in the case of systems according to UMTS and E-UTRA standards (reuse-1 systems), can be avoided.

The German Federal Network Agency for Electricity, Gas, Telecommunications, Post and Railway [BNetzA], for example, requires that the receiving level be limited along the outer borders of the Federal Republic of Germany for the operation of UMTS networks in Germany and neighboring countries that would lead to an area that is up to approximately 6 km wide on both sides of the border that cannot be covered by UMTS. A corresponding requirement is also present in general for Europe in the documents of the ERC (European Radiocomms Committee ERC TG1).

This recommendation of the ERC, however, leaves it up the mobile communication network operators on both sides of the country border to either maintain the maximum receive level or to reliably prevent interference between neighboring mobile communication networks in another way.

Within the framework of the UMTS standardization, in 3 GPP, the concept of the “equivalent PLMNs” was implemented. With it, it is possible to communicate to a mobile communication terminal (UE), in addition to the mobile communication network (PLMN) in which it is currently registered, additional PLMN identifications as “equivalent PLMNs” [compare 3GPP TS 24.008]. These (additional) PLMNs are treated by the mobile communication terminal (UE) for cell selection (network or cell selection), cell reselection (renewed cell selection) and hand-over (hand-over to a different (neighboring) cell) as if they were associated with the registered PLMN.

Among other things, the concept is used to support a seamless transition of a mobile communication terminal from one PLMN into another. For this, the terminal devices in the border region are informed not only of the neighboring cells of the inherent PLMN, but of the neighboring cells of a “friendly” PLMN, for example, those of a cooperating or the same network operator (to which service availability that is free of interruptions is to be ensured) and as the result of corresponding signaling from the UE, considered to be equivalent to the cells of the registered PLMN. The determination of the equivalent PLMNs takes place on a location/routing area (LA/RA) basis and when suitably supported by the network, in addition, also on a subscriber basis.

As an example of a first domestic network, for example, Germany, in the cells, i.e. in the local areas (LAs) in the border regions with the foreign country, for example, Austria, the neighboring cells of a second foreign country network of a cooperating (or the same) operator would, in addition to the cells of the first domestic network, receive signals of potential candidates for a cell hand-off. According to the configuration “foreign country network equivalent to the domestic network,” for the mobile communication terminal (user equipment=UE), the transfer (“cell reselection”) into the neighboring network, i.e. the foreign country network in Austria, would look like a normal hand-over of the cell (or various LAs) within a network, i.e. within a PLMN, and after the selection of a cell of the network of the foreign country, i.e. the second mobile communication network, it would perform a normal location area update (LAU) and be registered corresponding to the foreign country network.

For a mobile communication terminal (UE) with a configured ePLMN list (for which the second mobile communication network, i.e. here the network of the foreign country Austria the hand-over takes place equivalent with the first mobile communication network, the domestic network Germany), at that moment at which a mobile communication cell of the network of the foreign country (Austria) has a better radio quality according to the criteria for cell reversal specified by 3GPP than the actually used cell of the domestic network (Germany). A reversal thus takes place dependent on the communication signal strength (network intensity) at the respective location of the mobile communication terminal.

This represents a type of basic principle for the blending or merging of the mobile communication networks of several is providers or across borders. In addition to the use of “equivalent PLMN” at the borders of countries, this method is used today preferably also within the scope of national co-operations of several mobile communication network operators (national roaming).

A similar method also applies in the case of a hand-over, i.e. a transfer of an existing mobile communication connection (i.e. while the mobile communication participant is making, for example, a call (CELL_DCH in UMTS, HSPA) between these two networks. Neighboring cells that are signaled as being associated with an equivalent PLMN would be considered in the measurements located in the network (for example, by means of MEASUREMENT CONTROL message) just like normal cells and in the measurement reports to the RNC (radio network controller, a controller of several cells of the mobile communication network) would be reported for analysis (in the event the corresponding requirements are satisfied->“measurement events”).

The object of the invention is to provide a method that makes it possible to prevent a gap in coverage in the border regions of countries between two PLMNs, and to thus ensure the service quality for the mobile communication customers up to the country border, a method of this type having to preclude the negative effects caused by the respective mobile communication networks (PLMNs), as well as also the negative interference of other mobile communication networks (PLMNs).

In accordance with the invention, this object is attained by a method according to Claim 1.

Thus it is particularly advantageous that in a method of operating a first cellular mobile communication network, in particular, for operating cells in the border regions of the first cellular mobile communication network, where the first mobile communication network is identifiable by an identifier and in a mobile communication terminal to which a communication link exists—at least in border regions of the first mobile communication network the identification of a second, neighboring communication network that is identified as being equivalent—is transmitted, at least a partial spatial overlay of the communication ranges of the two mobile communication networks being present, with the mobile communication terminal measuring the communication signal strengths of the mobile communication networks that can be received at that time by the mobile communication terminal at the current location of the mobile communication terminal, in which the signal strengths measured by the mobile communication terminal and the associated identifiers of the respective mobile communication network are transmitted to the first mobile communication network for analysis, the hand-over of the communication connection to the second neighboring mobile communication network taking place if the communication signal strength of this second network exceeds a predetermined threshold value or is larger than the communication signal strength of the first mobile communication network, and that a check is performed by the second mobile communication network to determine if a right of use exists for the mobile communication terminal in the second mobile communication network, where upon an existing right of use, the communication connection is taken over by the second mobile communication network and maintained, and that the hand-over of the communication connection is rejected by the second mobile communication network if no right of use is present.

As a result of this it is possible to prevent gaps in coverage on one side or on both sides of the border of a country, upon using, in particular, in the case of cellular mobile communication systems based on the 3GPP standard, the knowledge of the best receiving properties in order to prevent or permit the hand-over between the respective mobile communication networks (PLMNs) of a mobile communication terminal (UE) in a targeted manner by means of network control, as a result of which a mobile communication network can be designed in such a way that up to the border of a country the required transmission power is available, but at the same time interference between the two neighboring mobile communication networks is avoided.

Henceforth, the method according with the invention makes it possible to eliminate the region not covered on both sides of the border, and ensure significant additional expanded availability of service up to the border for customers of the mobile communication network operators on both sides of the border. Especially important or advantageous is the use of this method in regions that must be served with sufficient network cover because of their population density (high density areas), i.e. with UMTS or the like (in the case of the Federal Republic of Germany these are, for example, the cities Aachen, Passau, Lindau, Frankfurt/O.), but also at borders of highways or airports that are close to borders (Copenhagen, Geneva) that should also be served with a higher likelihood, for example, with UMTS or the like and that naturally quickly have capacity bottle necks. In principle, an application of the method extending along all country borders is possible and expedient. Further, the method in accordance with the invention is not limited to use in systems according to the UMTS standard. Use of this method is in particular also expedient and advantageous in building novel cellular mobile communication networks according to E-UTRAN standards.

Further advantageous embodiments of the invention are laid out in the dependent claims.

It is advantageous if upon rejection of the hand-over by the second mobile communication network a corresponding message is generated that is transmitted to the mobile communication terminal, i.e. that a mobile communication terminal has been refused during the hand-over from a first network (PLMN) in a different network, the other PLMN that was configured as equivalent PLMN (ePLMN=equivalent PLMN), and upon transfer in the other PLMN the location/routing/tracking area update of the target PLMN that is to be performed is refused (for example, by answering with a LAU/RAU/TAU reject message).

Moreover, it is advantageous when in the rejection of the hand-over and/or receiving a corresponding message a network search of the mobile communication device is initiated.

As a result of this, in a mobile communication terminal (UE) that should be rejected during the hand-over to a cell of the neighboring network (neighbor PLMN), a LAU/RAU/TAU reject message is sent, a PLMN selection, i.e. a network search of the UE is initiated.

Preferably, the first mobile communication network cut of the connection with the mobile communication terminal when the communication signal strength of the neighboring second mobile communication network exceeds a predetermined threshold value or that is larger than the communication signal strength of the first mobile communication network when the second mobile communication network is not configured as being equivalent.

It is thereby possible that the neighboring cells of the neighboring PLMN are connected to a mobile communication terminal (UE) in an active connection (for example, CELL_DCH in UMTS or LTE_ACTIVE in E-UTRAN) and upon attaining a selected threshold value (for example, the cell of the neighboring PLMN is approximately equally strong as the best one of the actual PLMN) no hand-over, i.e. no transfer into this cell is triggered, but this measurement report triggers interruption of the call/data connection and thus interference with the cells of the neighboring PLMN is prevented.

Preferably, the first mobile communication network is formed by a number of cells, with a certain number of cells being controlled by a controller and an analysis of the communication signal strengths transmitted by the mobile communication terminal and the associated network identification being performed by the controller. An alternative embodiment makes use of it in cells of a mobile communication network possible where the actual control is performed in a base station.

Preferably, the first mobile communication network is formed by a number of cells and an analysis of the communication signal strengths and the associated network identifications transmitted by the mobile communication terminal are performed by the local controller.

Preferably, the first mobile communication network interrupts an active connection with a mobile communication terminal as soon as a cell of the second mobile communication network is reported by the mobile communication terminal that has a better quality or a quality that is above a defined threshold value.

Moreover, the invention concerns a computer program product comprising a computer program that can be executed on a central processing unit that executes the method according to the invention as per one of claims 1 to 5, if it is executed in a central processing unit, in particular, in a central processing unit of a controller or the like of a mobile communication network, in particular a radio network controller (for example, a RNC or an eNB) or a core network node (for example a SGSN or a MME).

In the following, the invention is explained in conjunction with figures. Therein:

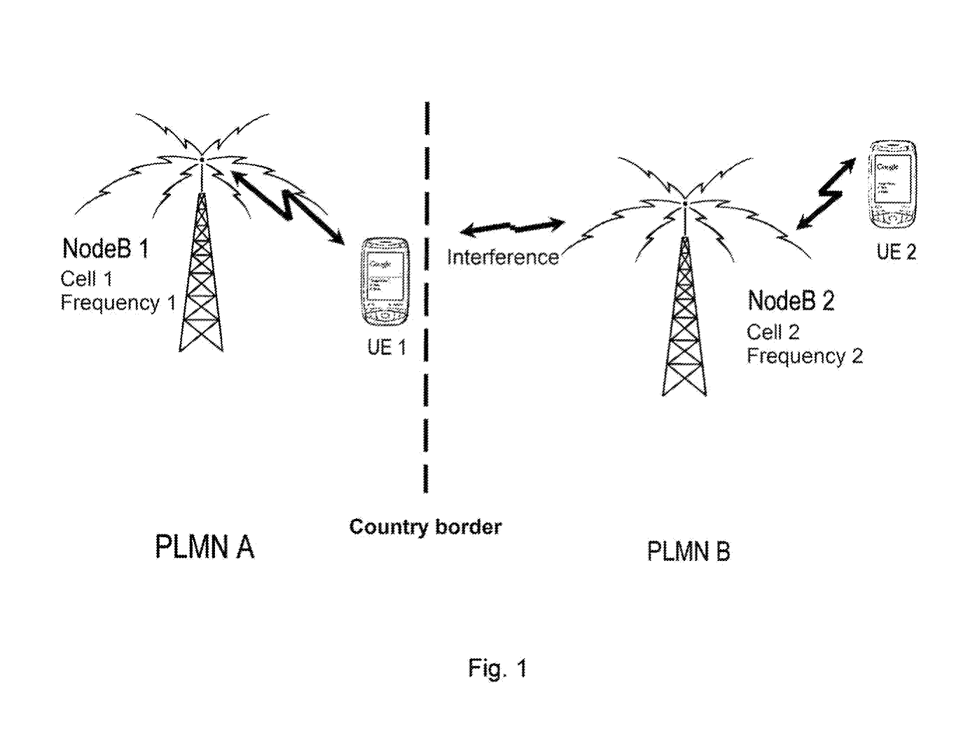

FIG. 1 is a schematic illustration of the interference of two neighboring mobile communication networks;

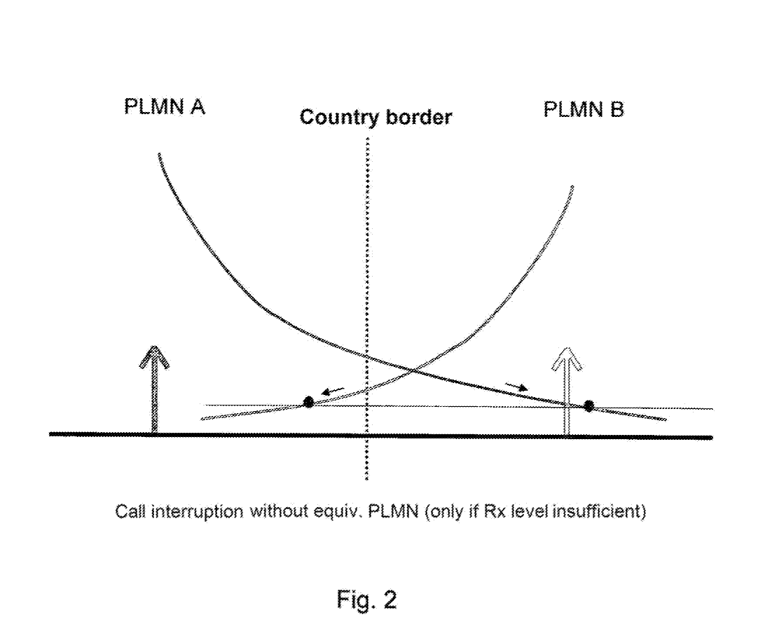

FIG. 2 shows the progression of the communication signal strength (network intensity) in the border region between two neighboring mobile communication networks and the region of interruption of a call without equivalent networks (PLMN);

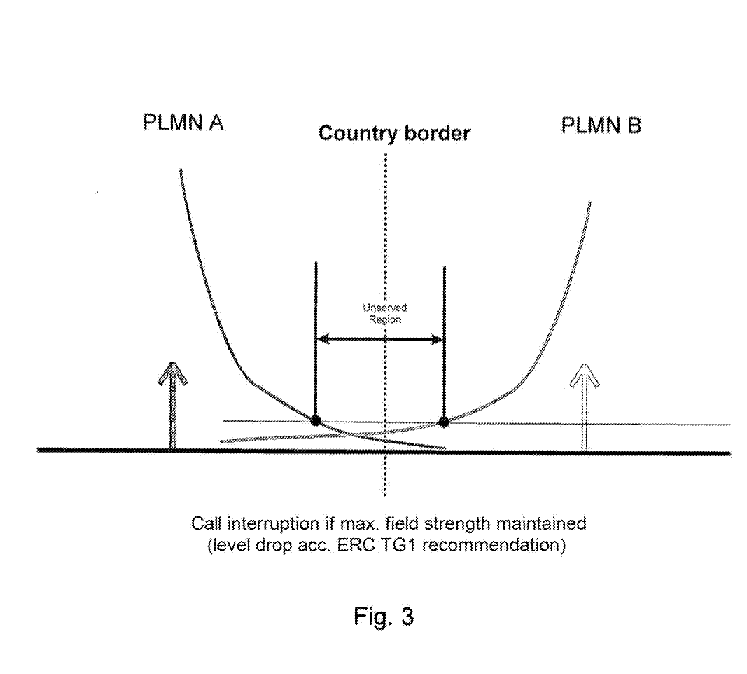

FIG. 3 shows the progression of the communication signal strength (network intensity) in the border region between two neighboring mobile communication networks and the region without service when maintaining the minimum distance to the border;

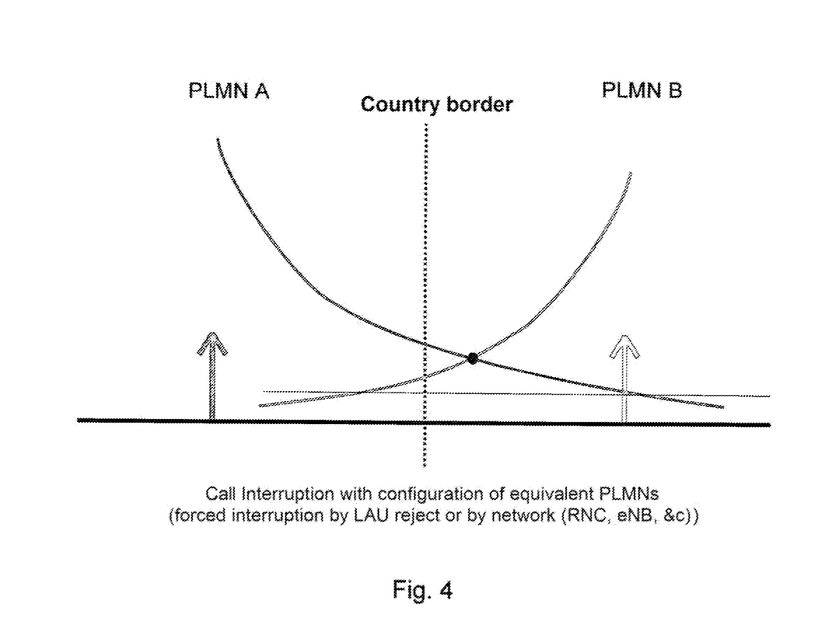

FIG. 4 shows the progression of the communication signal strength (network intensity) in the border region between two neighboring mobile communication networks and the region of interruption of a call when using equivalent networks (ePLMN).

The basic problem in the border region between two neighboring mobile communication networks (PLMNs) is illustrated in FIG. 1, where when using the same frequency “1” in both networks, interference can result with respect to one mobile communication terminal, UE1 in the first network and UE2 in the second network.

If one the networks is in such a way that network coverage, i.e. a sufficient communication signal strength, is to be provided up to the border, for example the country border, without the use of the principle of equivalent networks (ePLMN) as shown in FIG. 2, interference can occur and dropping of the call occurs only beyond the border when the communication signal strength (network intensity) becomes too weak and interference is already being created in the neighboring network.

Alternative to this, for the prevention of interference in the border region between two neighboring mobile communication networks, the transmitting power can be selected according to the configuration of the cells in the border region, as shown in FIG. 3, i.e. on both sides a corresponding distance is maintained up to the border with the consequence of a very broad strip along the border that is not covered by the communication network.

In order to avoid the negative effects of the border coordination/noncoverage caused by BNetzA/ERC (an up to approximately 12 km wide strip without UMTS coverage along the border of a country), the concept of equivalent PLMNs (ePLMN—equivalent Public Land Mobile Network) can also be used and be expanded as per the method according to the invention. To this end, however, coordination of the network operators on both sides of the border is required, even if a reciprocal hand-over (transfer of the connection) is not desired perhaps for commercial, regulatory or strategic reasons or not allowed. However, the intelligent use of the equivalent PLMN concept makes coverage by UMTS or the like up to the country border possible and the defined interruption of a connection, so that interference with the neighboring operator by (uplink) interference of the UE is avoided, as shown in FIG. 4.

In the region of the (country) border, the cells of the network operator operating on the other side are reciprocally broadcast on the system information blocks (SIB) of the broadcast channel (BCCH) and the PLMN identities of both network operators in the location areas (LA) along the border are communicated to the terminal device as being equivalent PLMNs (ePLMN).

In the event of a cooperation of two mobile communication network operators on both sides of the border, the configuration of the required information of the ePLMN and the registration of the respective neighborhood relationships (neighboring cells) is required so that on crossing the border the existing mobile communication connection is handed over to the neighboring mobile communication network, as shown in the above example between a first German network and a second Austrian network.

But as a targeted collaboration of the network operators on both sides of the border is not always desired, the method in accordance with the invention proposes that even in the case of an undesired hand-over to the corresponding network of the mobile communication operator on the other side of the border, these networks are signaled to the mobile communication terminals and the subsequent location area update (LAU) is rejected as soon as the mobile communication terminal (UE) is in the cells that are covered better as per the criteria specified by the 3GPP on the other side of the border. By using this method, the region that is not covered becomes unnecessary, as a UE is in the cell of the original PLMN up to reaching the border (based on plan specifications and network parameterization), and by going across the border, changes to the cell of the neighboring country that is covered best (FIG. 4) and then as the result of a rejection (by an LAU reject) access to the new network is denied. By way of expansion, a corresponding cause value of the LAU reject finally forces the selection of a different PLMN (of the neighboring country) in order to be able to make service available to the user after entering the other country.

An application for use of the method in accordance with the invention is a user of a mobile communication operator A-Germany (HPLMN) who has used the network of operator B-Netherlands (VPLMN) and is geographically moving toward the border with Germany. This user will be handed over by an assignment
<B-Netherlands equivalent B-Germany>
   at the border to the best-covered cell (of operator B-Germany) but there, as the user typically (with the exception of national roaming) has no access to the network of operator B-Germany, is rejected by a LAU reject, and can thus generate no additional interference against the network of operator B-Germany. The interference that is caused is no higher than in the normal case, just like when a cell of the inherent network is a neighboring cell. By means of an optional use of the PLMN selection specified by 3GPP (according to a corresponding LAU reject cause [3GPP TS 24.008]), the mobile communication terminal (UE) is sent to its home network, for example, the network A-Germany by operator A. This example shows that by using the method in accordance with the invention, a “gentle” hand-over between the PLMNs of various countries is possible, the uncovered region can be avoided to avoid interference, and in addition, targeted control of the access/non-access to the respective PLMNs can be realized.

In general, the specification of the method in accordance with the invention can be used especially favorably even in the case of an active call during the hand-over between two PLMNs/countries:

As a result of the configurations of the respective neighboring cells on both sides of the border and perhaps the additional assignment that both PLMNs are equivalent, during a call (CELL_DCH in UMTS), the cells of the other operator are also analyzed by the mobile communication terminal (UE) and the measurement results are communicated to the serving RNC (SRNC) of the respectively covering network.

In order to avoid interference during the hand-over between the PLMNs, in the RNC (radio network controller=controller) or eNB (in the event of E-UTRAN), an algorithm as per the method in accordance with the invention is to be implemented that recognizes the cells (cell identity) of the other operator, configures as per these measurements done by the mobile communication terminal (UE) and analyzes incoming measurement results of the UE when a cell that is not associated with the inherent PLMN has a better (communication quality) quality than the strongest inherent cell. As soon as a cell of the neighboring network (PLMN) has a higher level/communication quality than the strongest cell of the inherent network, i.e. always when normally a hand-over would take place, the SRNC or the serving eNB decides that the call is to be interrupted (for example, by sending an RRC CONNECTION RELEASE message in UMTS systems). Thus way, the call is actively dropped, even before an increase in interference can occur in the cells of the neighboring country, however, coverage is ensured up to the country border.

Alternatively, as it is customary in the case of “friendly” PLMNs, a hand-over to the network of the neighboring country can take place (if necessary, also to a different frequency).

The use of this method is not limited to use in UMTS with dedicated channels (R′99 DCHs), but can also be done the same way in the case of network control of the terminal mobility, also by HSPA or E-UTRAN networks. The use of the method in accordance with the invention is not limited to the examples mentioned above, but can be implemented in principle with all cellular mobile communication systems, regardless of standard.

The method is illustrated in FIG. 4: A mobile communication terminal UE that is moving from a first mobile communication network PLMN1 toward a second mobile communication network PLMN2 (i.e. from left to right) should lose the call at that point at which the cell of the PLMN2 becomes stronger than the (serving) cell of the PLMN1. Normally, interruption of the call would only take place upon reaching the minimum reception level (thin black line) on the other side of the country border (shown in FIG. 4).

But here, the interference for the PLMN2 as a result of the UE that is still connected with nodeB (base station) of the PLMN1, is so large that significant interference would occur for this cell (compare FIG. 1). This problem (near-far problem) is of great significance especially in CDMA networks (for example UMTS) or in general upon reuse-1 communication systems, as also E-UTRAN, as because of the interference, the quality of all connections in the cell of the PLMN2 experiencing the interference would fall.

The method in accordance with the invention must necessarily be implemented on both sides of the border (i.e. in both PLMNs). As a consequence, the PLMN that does not implement this method, cannot expand its own services as described above, but would have to unilaterally lower the level as described in [ERC REC 01-01], in order to avoid interfering with other mobile communication systems.

1. A method of operating a first cellular communication network in the border region of the first cellular mobile communication network identifiable by an identifier and where a mobile communication terminal to which a communication link exists transmits, at least in border regions of the first mobile communication network, the identification of a second neighboring communication network identified as being equivalent, there being an at least partial spatial overlay of the communication ranges of the two mobile communication networks, the mobile communication terminal measuring the communication signal strengths of the mobile communication networks that can be received at that moment by the mobile communication terminal at the momentary location of the mobile communication terminal, wherein the signal strengths measured by the mobile communication terminal and the associated identifiers of the respective mobile communication network are transmitted to the first mobile communication network for analysis, the communication connection being handed over to the second neighboring mobile communication network if the communication signal strength of this second network exceeds a predetermined threshold value or that is larger than the communication signal strength of the first mobile communication network, and that a check is performed by the second mobile communication network to determine if a right of use exists for the mobile communication terminal in the second mobile communication network, where with an existing right of use the communication connection is taken over by the second mobile communication network and maintained, and that the takeover of the communication connection by the second mobile communication network is rejected if no right of use exists.

2. The method according to claim 1, wherein on rejection of the takeover by the second mobile communication network, a corresponding message is generated and transmitted to the mobile communication terminal.

3. The method according to claim 1 wherein upon rejecting the takeover and/or receiving a corresponding message, a network search of the mobile communication terminal is initiated.

4. The method according to claim 1 wherein the first mobile communication network disconnects the communication connection to the mobile communication terminal when the signal strength of the neighboring second mobile communication network exceeds or a predetermined threshold value or is larger than the communication signal strength of the first mobile communication network, when the second mobile communication network is not configured as being equivalent.

5. The method according to claim 1 wherein the first mobile communication network is formed by a number of cells, a certain number of cells being controlled by a controller and an analysis of the communication signal strengths transmitted by the mobile communication terminal and the associated network identification is performed by the controller.

6. The method according to claim 1 wherein the first mobile communication network is formed by a number of cells and an analysis of the communication signal strengths transmitted by the mobile communication terminal and the associated network identification is made by the local controller.

7. The method according to claim 1 wherein the first mobile communication network interrupts an active connection with a mobile communication terminal as soon as the mobile communication terminal reports a cell of the second mobile communication network that has a better quality or a quality above a defined threshold value.

8. A computer program product comprising a computer program that can be executed on a central processing unit that executes the method according to claim 1 if it is performed in a central processing unit, in particular in a central processing unit of a controller or the like of a mobile communication network.
